(19) United States
(12) Patent Application Publication
(10) Pub. No.: US 2009/0018963 A1
(43) Pub. Date: Jan. 15, 2009

(54) SYSTEM AND METHOD TO RE-SELL DIGITAL CONTENT WITH ADVERTISEMENT

(75) Inventor: HOSAME ABU-AMARA, ROUND LAKE, IL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/775,632

(22) Filed: Jul. 10, 2007

(51) Int. Cl. G06Q 30/00; H04L 9/00

(52) U.S. Cl. 705/59; 705/14

(57) ABSTRACT

A system (100) for re-selling DRM content (120) can have advertising (AD) contents (140) attached thereto. The system can include a rights issuer (RI) (171) for providing re-sale rights to access and re-sell DRM content provided by a content provider, and a presentation module (PM) (172) for presenting the DRM content with AD content. The PM can present the DRM contents with AD contents if the DRM contents are not purchased with an advertisement suppression option (123). Alternatively, the PM can present the DRM content without AD contents if the DRM contents are purchased with advertisement suppression option. An AD key (145) can be distributed upon purchase of the advertisement suppression option to suppress the presentation of AD content with the DRM content. The AD contents can be updated before re-sale and the DRM contents or a DRM key (125) can be removed from the seller upon the re-sale.

### FIELD OF THE INVENTION

The exemplary embodiments of the present invention generally relate to systems and methods for Digital Rights Management (DRM), and more particularly to a system and method for advertising to re-sell digital content.

### BACKGROUND

One critical aspect to enable the development of widespread distribution of digital works, for example, documents or other content in forms readable by computers, and management of the use of digital works via electronic means, mobile devices, and the Internet, is the ability to designate and enforce the intellectual property rights and other rights of content owners, consumers and other stakeholders during the distribution and use of digital works. Efforts to meet this need have been termed Intellectual Property Rights Management (IPRM), Digital Property Rights Management (DPRM), Intellectual Property Management (IPM), Rights Management (RM), and Electronic Copyright Management (ECM), collectively referred to as Digital Rights Management (DRM).

Presently, a user can purchase and download media content, such as music, and with the purchase, receive a license to use the media content, for example, to listen to the music. Understandably, the song may be the property of an artist or a company, who grants rights to the purchaser of the media content. The license allows the user to consume the content according to the rights, though the license generally restricts the user from selling the media content to other users.

This can present a disadvantage from a marketing perspective when compared with protected content that is available on discrete media such as compact discs (CDs) or digital video discs (DVDs). For instance, when a user purchases a CD, the user can sell the CD because the CD becomes the user's property as a result of the purchase. Although the user is generally restricted from copying the CD, the user may be entitled to sell the CD.

The same benefits of selling are not generally provided to a user who purchases digital content via download. In such cases, the user is generally provided a digital copy of the media content with a non-transferable license.

### BRIEF DESCRIPTION OF THE DRAWINGS

The features of the system, which are believed to be novel, are set forth with particularity in the appended claims. The embodiments herein can be understood by reference to the following description, taken in conjunction with the accompanying drawings, in the several figures of which like reference numerals identify like elements, and in which:

FIG. 1 depicts an exemplary system for re-selling digital rights management (DRM) content in accordance with an embodiment of the present invention;

FIG. 2 depicts an exemplary illustration for re-selling DRM content with purchase of re-sale rights and advertisement suppression option in accordance with an embodiment of the present invention;

FIG. 3 depicts an exemplary illustration for re-selling DRM content with purchase of re-sale rights but without advertisement suppression option in accordance with an embodiment of the present invention;

FIG. 4 is a flowchart illustrating method steps for purchasing DRM content in accordance with an embodiment of the present invention;

FIG. 5 is a flowchart illustrating method steps for re-selling DRM content in accordance with an embodiment of the present invention; and

FIG. 6 is a block diagram of an electronic device in accordance with an embodiment of the present invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “processing” or “processor” can be defined as any number of suitable processors, controllers, units, or the like that are capable of carrying out a pre-programmed or programmed set of instructions. The terms “program,” “software application,” and the like as used herein, are defined as a sequence of instructions designed for execution on a computer system. A program, computer program, or software application may include a subroutine, a function, a procedure, an object method, an object implementation, an executable application, a source code, an object code, a shared library/dynamic load library and/or other sequence of instructions designed for execution on a computer system.

The term “re-sale” rights can be defined as terms of an agreement which permit a purchaser of DRM content to re-sell the DRM content. The term “advertisement suppression option” can be defined as an option to suppress a presentation of advertisements during a presentation of DRM content. The term “peer-to-peer” can be defined as direct communication between a first peer and at least a second peer. The term “peer-to-server-to-peer” can be defined as communication between a first peer and at least a second peer with the support of a server. The term “DRM content” can be defined as information that has ownership rights, such as music, software, files, or data but not herein limited to these. The term “AD content” can be defined as advertisements in the form of video clips, audio clips, text messages, video advertisements, or other media presentation types any of which can include promotional material, bargains, deals, or directions though not herein limited to these.

There are several reasons transfer restrictions may be placed on DRM systems. One reason may be that content providers fear loss of revenue if re-selling is allowed. Another reason may be a concern that it may be difficult to ascertain that DRM content is removed from the re-seller upon re-sale. Yet another reason may be the lack of apparent incentive for a purchaser to buy DRM content at full price when the purchaser can obtain the DRM content from a re-seller at a discount. Accordingly, a need therefore exists for providing incentives to content providers to enable re-selling of DRM content.

One embodiment of the present invention is a system for re-selling DRM content having advertising (AD) contents attached thereto. The system can include a rights issuer (RI) for providing re-sale rights to access and re-sell DRM content provided by a content provider, and a presentation module (PM) for presenting the DRM content with the AD content. In one arrangement, the PM can present the DRM contents with the AD contents if the DRM contents are not purchased with advertisement suppression. Alternatively, the PM can present the DRM content without the AD contents if the DRM contents are purchased with advertisement suppression.

The RI responsive to a purchasing of the DRM content without advertisement suppression can distribute a DRM key that when accompanied with the DRM content permits the PM to present the DRM content with the AD contents such that DRM content is presented with the AD contents. The RI responsive to a purchasing of the DRM content with advertisement suppression can distribute an AD key that when accompanied with the DRM content prevents the PM from presenting the AD contents such that DRM content is presented without AD contents.

In one arrangement, a first DRM device that in response to purchasing the DRM content without advertisement suppression and with re-sale rights receives the DRM key and a license to re-sell the purchased DRM content. The DRM key allows the DRM content to be presented with the AD contents. In a second arrangement, the first DRM device that in response to purchasing the DRM content with advertisement suppression and with re-sale rights receives the DRM key, an AD key, and a license to re-sell the purchased DRM content. The AD key allows the DRM content to be presented without the AD contents. The AD key can suppress the presentation of AD content permitted by the DRM key.

A second DRM device that in response to purchasing the DRM content from the first DRM device through a re-sale can receive the DRM key. Upon transfer of the DRM contents from the first DRM device to the second DRM device, the RI can direct the first device to remove the DRM key from the first DRM device. The RI, the first DRM device, or a DRM agent in the first DRM device, can send a receipt of re-sale to the content provider acknowledging that a second DRM device has purchased the DRM content through a re-sale from the first DRM device. The RI or content provider can also update the AD contents before the DRM content is delivered through a re-sale from the first DRM device to the second DRM. The second DRM device, which has received the DRM key as a result of the re-sale, can present the DRM content with the AD contents. If requested, the first DRM device can direct the second DRM device to a content provider to suppress the presentation of the AD contents. The first DRM device and the second DRM device can operate in a peer-to-peer mode or in a peer to server to peer mode.

A second embodiment of the present invention is a method for re-selling digital rights management (DRM) content. The method can include attaching AD contents to the DRM content, and managing a presentation of the AD contents with the DRM content in accordance with rights purchased for the DRM content. The rights establish whether the DRM contents are presented with the AD contents or without the AD contents. The method can further include determining if re-sale rights are purchased with the DRM content, and presenting the DRM content with the AD contents if the DRM contents are purchased without advertisement suppression and with re-sale rights, and presenting the DRM content without the AD contents if the DRM contents are purchased with advertisement suppression and with re-sale rights.

In practice, a DRM key can be provided responsive to a purchase of the DRM content that when accompanied with the DRM content permits a presentation the AD contents with the DRM content. An AD key can be distributed with the DRM content and attached AD contents if advertisement suppression is purchased with the DRM content. The AD key can prevent a presentation of the AD contents such that the DRM content is presented without AD contents. A receipt of re-sale can be sent to a content provider supplying the DRM content acknowledging that a second DRM device has purchased the DRM content through a re-sale from a first DRM device.

The DRM content can be delivered with the DRM key but without the AD key responsive to a re-sale of the DRM content. The AD contents can also be updated before the DRM content is delivered through a re-sale. In such regard, the DRM content when consumed by a DRM device that purchased the DRM content through a re-sale presents the DRM contents with the updated AD contents. The DRM keys can be removed from the DRM device selling the DRM content upon a re-sale of the DRM content to the DRM device purchasing the DRM content. Alternatively, a DRM device can be directed to a content provider to purchase the DRM content with a DRM key and an AD key. In such regard, responsive to a purchase of the DRM content with advertisement suppression, the DRM content can be presented without the AD contents.

A third embodiment of the present invention is a mobile device for re-selling digital rights management (DRM) content having advertising (AD) contents attached thereto. The mobile device can include a rights issuer (RI) for providing rights to access and re-sell the DRM content provided by a content provider, and a presentation module (PM) for presenting the DRM content with or without the AD contents. The presentation module can present the DRM contents without AD contents if the DRM contents are purchased with advertisement suppression, and present the DRM content with the AD contents if the DRM contents are purchased without advertisement suppression. A DRM key and an AD key are provided with a purchase of an advertisement suppression option. Although the DRM key is provided if advertisement suppression is not purchased, the AD key is not provided if advertisement suppression is not purchased. The PM can present the DRM contents on the mobile device without the AD contents if both the AD key and the DRM key are present. The PM can present the DRM contents on the mobile device with AD contents if the DRM key is present but the AD key is not present.

The RI, a first DRM device, or a DRM agent in the first DRM device, can distribute the DRM key with the DRM content and AD contents responsive to a second mobile device purchasing the DRM content from the first DRM device. In such regard, the DRM content is purchased in a re-sale of the DRM contents from the first mobile device to the second mobile device. The RI can contact an advertising server to update the AD contents before delivering the DRM contents to the second mobile device. The RI can then transfer the DRM key with the DRM content and AD contents attached thereto without the AD key, such that the second device presents DRM content with AD contents. The RI can remove the DRM key on the mobile device upon the re-sale of the DRM content to the second mobile device.

Broadly stated, embodiments of the invention are directed to re-selling digital rights management (DRM) content with advertisements. The advertising may offset losses to content providers resulting from the re-sale of content. Prospective purchasers of the digital content can choose to either buy previously owned content at an inexpensive price but with advertisements, or buy the digital content with fewer or no advertisements at a higher price.

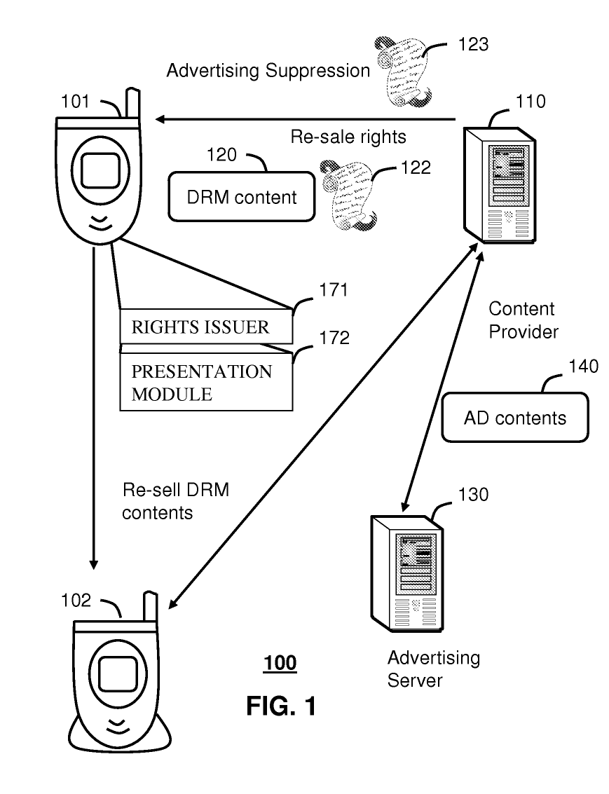

Referring to FIG. 1, a system 100 for re-selling digital rights management (DRM) content having advertising (AD) contents attached thereto is shown. The system 100 can include a content provider 110 for generating and providing DRM content 120 with associated re-sale rights 122 to re-sell the DRM content 120 and an advertisement suppression option 123 to suppress advertisements presented with the DRM content 120. The system 100 can include an advertising server 130 for generating and providing advertisement (AD) contents 140 associated with the DRM contents 120. The advertising suppression option 123 can determine whether the AD contents 140 are presented with the DRM content 120. The system 100 can include a first mobile device 101 that can receive DRM content 120 from the content provider 110. A second mobile device 102 can receive the DRM content 120 from the first mobile device 101 in a re-sale purchase of the DRM content 120. The DRM content 120 can be media, music, data, files, software, or any other digital storage media. The re-sale rights 122 specify agreements for presenting the DRM contents 120 with the AD contents 140. The re-sale rights 122 can be in the form of standard text, encrypted text, computer code, machine code or any other digitally transferable format. The advertisement suppression option 123 can be in the form of a cryptographic key. In one aspect, the re-sale rights 122 can be rendered on a display of the mobile device 101 to inform the user of the rights or agreements associated with a purchase of the DRM content 120.

The system 100 can include a rights issuer (RI) 171 and a presentation module (PM) 172. The RI 171 provides re-sale rights to access and re-sell DRM content 120 provided by the content provider 110. The PM 172 determines whether the DRM content 120 is presented with the AD contents 140. In one embodiment, as shown, the RI 171 and the PM 172 can be on a mobile device 101, performing as a DRM agent. In another embodiment the RI 171 and the PM 172 can be a server, such as the content provider 110, or any other networked system. Briefly, the PM 172 can present the DRM contents 120 without the AD contents 140 if the DRM contents 120 are purchased with the advertisement suppression option 123. Alternatively, the PM 172 can present the DRM content 120 with the AD contents 140 if the DRM contents 120 are purchased without the advertisement suppression option 123.

In one arrangement, the RI 171, the first DRM device 101, or a DRM agent in the first DRM device, can distribute the DRM content 120 and AD contents 140 attached thereto, responsive to a second mobile device 102 that purchases the DRM content 120 from the first mobile device 101, if the first mobile devices 101 purchases the DRM content 120 with the re-sale rights 122. The purchase by the second mobile device 102 corresponds to a re-sale of the DRM contents 120 by the first mobile device 101 to the second mobile device 102. Responsive to the purchase, the RI 171 can remove the DRM content 120 on the mobile device 101 upon the re-sale of the DRM content 120 to the second mobile device 102. The second mobile device 102 can also be directed by the first mobile device 101 to purchase the re-sale rights 122 or the advertisement suppression option 123 from the content provider 110.

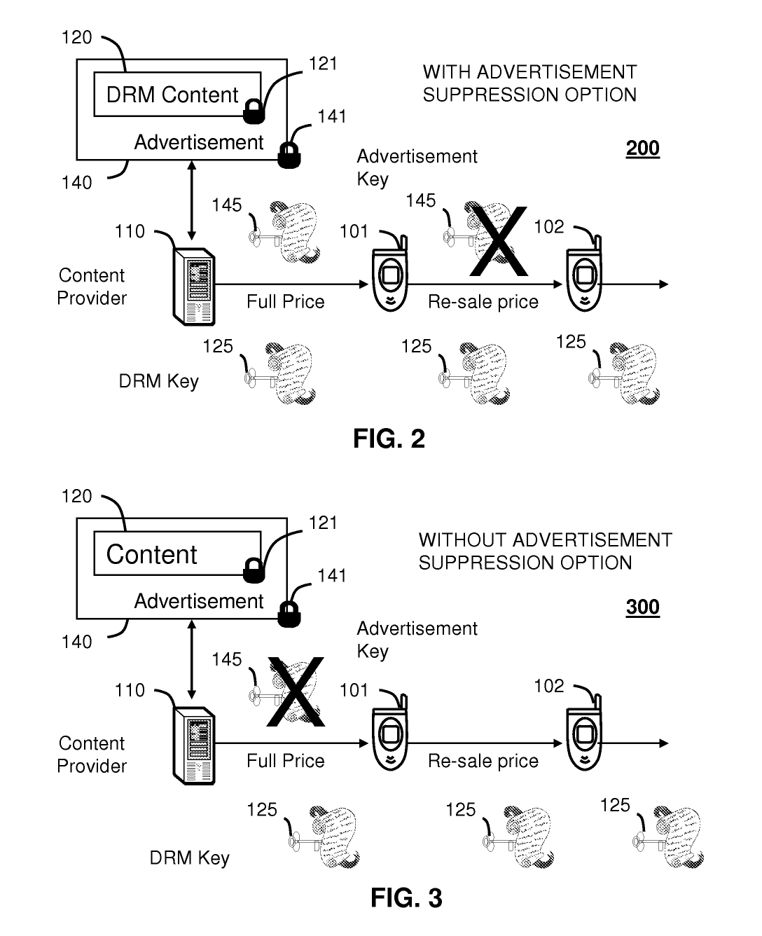

FIG. 2 depicts an exemplary illustration for re-selling DRM content 120 with a purchase of re-sale rights 122 and the advertisement suppression option 123 in accordance with an embodiment of the present invention. As shown, the DRM content 120 can be encapsulated or packaged with the AD contents 140 to produce packaged content. Two locks can be associated with the packaged content: 1) a DRM lock 121 that prevents access to the DRM content, and 2) an AD lock 141 that controls a presentation of the AD content 140. A DRM key 125 permits the DRM content 120 to be presented with the AD contents 140. An AD key 145 suppresses the presentation of the AD contents 140 with the DRM content 120 when the DRM key 125 is present.

As illustrated, the packaged content can be distributed to the first mobile device 101 responsive to a purchase of the DRM content 120 from the content provider 110. Upon purchase of the DRM contents 120 with the re-sale rights 122 (See FIG. 1) and the advertisement suppression option 123, the DRM key 125, the re-sale rights 122 (See FIG. 1) granting rights to re-sell the content, and the AD key 145 are provided to the first mobile device 101. In one arrangement, the re-sale rights 122 can be encoded with the DRM key 125. Upon, a re-sale of the DRM content 120 to a second mobile device 102, only the DRM key 125 and the re-sale rights 122 (See FIG. 1) are provided with the packaged content. The AD key 145 is not provided in the re-sale. In such regard, the second mobile device presents the DRM content 120 with the AD contents 140.

FIG. 3 depicts an exemplary illustration for re-selling digital rights management (DRM) content 120 with purchase of re-sale rights 122 but without advertisement suppression option 123 in accordance with an embodiment of the present invention. As illustrated, the packaged content can be distributed to the first mobile device 101 responsive to a purchase of the DRM content 120 from the content provider 110. Upon purchase of the DRM contents 120 with the re-sale rights 122 (see FIG. 1) but without advertisement suppression option 123, the DRM key 125 is provided to the first mobile device 101, although the AD key 145 is not provided. In such regard, the first mobile device 101 presents the DRM content 120 with the AD contents 140. Upon, a re-sale of the DRM content 120 to a second mobile device 102, only the DRM key 125 and the re-sale rights 122 (See FIG. 1) are provided with the packaged content. The AD key 125 is not provided in the re-sale. In such regard, the second mobile device also presents the DRM content 120 with the AD contents 140.

In an alternative scenario, the content provider 110 can distribute the packaged content to the first mobile device 101 responsive to a purchase of the DRM content 120 without the re-sale rights 122 but with the advertisement suppression option 123. Upon purchase of the DRM contents 120 without the re-sale rights 122 but with the advertisement suppression option 123, only the DRM key 125 and the AD key 145 are provided to the first mobile device 101. The re-sale rights 122 (See FIG. 1) are not provided to the first mobile device 101. In such regard, the first mobile device 101 presents the DRM content 120 without the AD contents 140, and the first mobile 101 is prevented from re-selling the DRM content 120 to a second mobile device 102. In practice, this may imply that the first mobile device 101 is prohibited from selling the DRM key 125 to the second device.

In another alternative scenario, the content provider 110 can distribute the packaged content to the first mobile device 101 responsive to a purchase of the DRM content 120 without the re-sale rights 122 and without the advertisement suppression option 123. Upon purchase of the DRM contents 120 without the re-sale rights 122 and without the advertisement suppression option 123, only the DRM key 125 is provided to the first mobile device 101. The AD key 145 and the re-sale rights 122 (See FIG. 1) are not provided to the first mobile device 101. In such regard, the first mobile device 101 presents the DRM content 120 with the AD contents 140, and the first mobile 101 is prevented from re-selling the DRM content 120 to a second mobile device 102. In practice, this may imply that the first mobile device 101 is prohibited from selling the DRM key 125 to the second device.

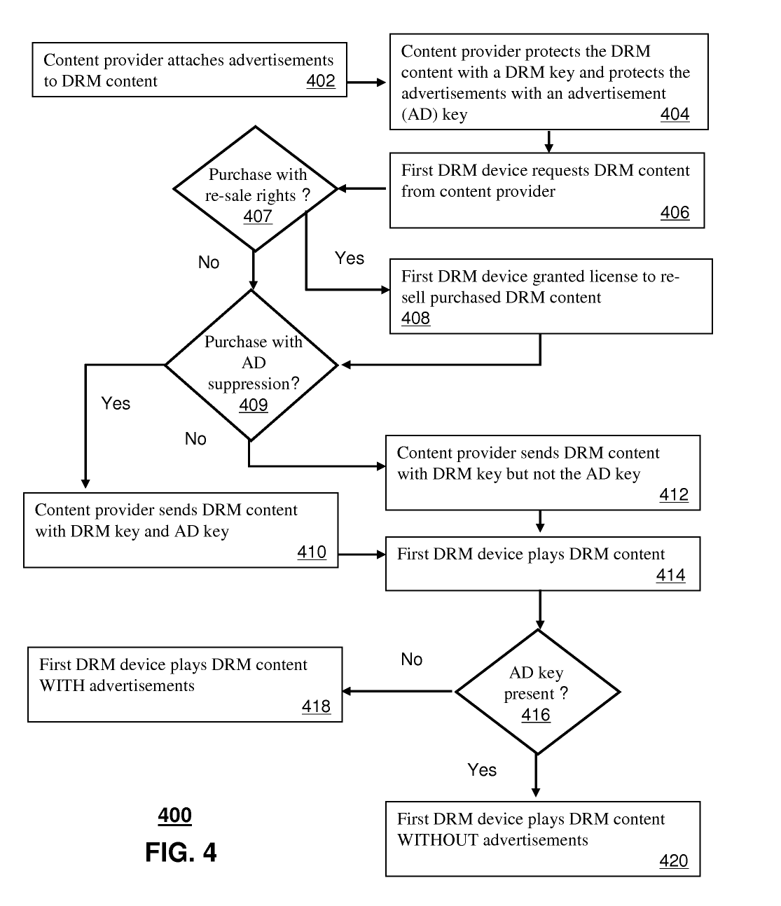

Referring to FIG. 4, a flowchart 400 illustrating method steps for purchasing digital rights management (DRM) content having advertising (AD) contents attached thereto is shown. It should be noted that the steps of the flowchart 400 may be practiced with more or less than the number of steps shown. Moreover, the flowchart 400 can be practiced by the components presented in FIG. 1 though is not limited to practice by the components shown. Reference will also be made to FIG. 1 when describing the steps of the flowchart 400.

The flowchart 400 can start at step 402 in which the content provider 110 attaches AD contents 140 to DRM content 120. The AD contents 140 can comprise audio, image, or video data in any format that can be digitally presented. As one example, the AD contents 140 can be encoded with the DRM content 120. As another example, the AD contents 140 can be streamed from the advertising server 130 during presentation of the DRM content 120. At step 404, the Content provider 110 protects the DRM content with the DRM key 125 and protects the advertisements with the AD key 145. The DRM key 125 is required to consume the DRM content, and the AD key 145 is required to prevent the advertisements from running when the content is consumed.

At step 406, the first DRM device 101 requests DRM content 120 from the Content provider 110. For example, a user of the first DRM device 101 can browse a web-site on-line and purchase a DRM content download, such as a song, or software. Upon requesting the DRM content 120, the user can be prompted with an option to purchase re-sale rights 122 to the DRM content 120 as shown in step 407. The agreement specifying the re-sale rights can be presented on a display of the first mobile DRM device 101 to visually inform the user of the rights granted. This provides a purchaser who contacts the content provider 110 with an option of paying for the DRM content 120 with re-sale rights 122, or paying for the DRM content without re-sale rights 122.

Briefly, the content provider 110 may elect to charge a higher price for purchasing the DRM content with re-sale rights 122 since the user will be granted rights to later sell the DRM content to a prospective purchaser. For example, after some period of time, the user may decide to sell the DRM content to another, if the re-sale rights 122 were purchased with the DRM content 120. Alternatively, the user can purchase the DRM content 120 without the re-sale rights.

If the user purchases the re-sale rights 122, the content provider 110 grants the user the right to re-sell the purchased content to other users. This right can be in the form of a license to re-sell the purchased content, as shown at step 408. On the other hand, if the user declines to purchase the re-sale rights 122, the content provider 110 prohibits the DRM device from re-selling the purchased content to other users. This prohibition can be enforced, for example, by the content provider 110 not granting a re-sale license to the purchasing device.

At step 409, the user is prompted with an option to purchase an advertisement suppression option 123 (See FIG. 2) for the DRM content 120. An agreement specifying the advertisement suppression option 123 can be presented on a display of the first mobile DRM device 101 to visually inform the user of the option. The agreement provides a purchaser who contacts the content provider 110 with an option of paying for the DRM content 120 with an advertisement suppression option 123, so that the DRM content 120 can be presented without the AD content 140, or paying for the DRM content without an advertisement suppression option 123, so that the DRM content 120 is presented with the AD content 140.

If the user declines the purchase of the advertisement suppression option 123, the content provider 110 at step 412 sends DRM content 120 with DRM key 125 but not the AD key 145. In such regard, the AD contents 140 will be presented with the DRM content 120 in the absence of the AD key 145. However, if the user purchases the advertisement suppression option 123, the content provider 110 at step 410 sends the DRM content with the DRM key 125 and the AD key 145. The AD key 145 is sent to the first DRM device 101, or purchaser operating the first DRM device 101, with the stipulation that the AD key 145 cannot be transferred or re-sold. However, the DRM key 125 is allowed to be transferred or re-sold only if the first DRM device, or purchaser operating the first DRM device 101, paid for the option of re-sale rights 122. It should be noted that the DRM key 125 and the AD key 145 can be distributed using various means (e.g. sent by email/instant messenger, attached to the DRM content, downloaded, or wi-fi transmission.)

When the first DRM device plays the DRM content 120 as shown in step 414, the RI 171 (See FIG. 1), the DRM device, or a DRM agent in the first device, determines if the AD key 145 is present as shown in step 416. If the AD key 145 is not present with the DRM key 125, the PM 172 plays DRM content 120 with the AD contents at step 418. As an example, the PM 172 may play a brief advertisement video, sound clip, or message prior to presenting the DRM content 120. Alternatively, banner advertisements or pop-ups may be played during the presentation of the DRM content 120. If the RI 171 (See FIG. 1), the DRM device, or a DRM agent in the first device, at step 416 determines that the AD key 145 is present with the DRM key 125, the PM 172 plays DRM content 120 without the AD contents 140 as shown in step 420. In such regard, the PM 172 having determined the DRM key 125 is accompanied by the AD key 145 suppresses the presentation of AD contents 145 otherwise presented by the DRM key 125.

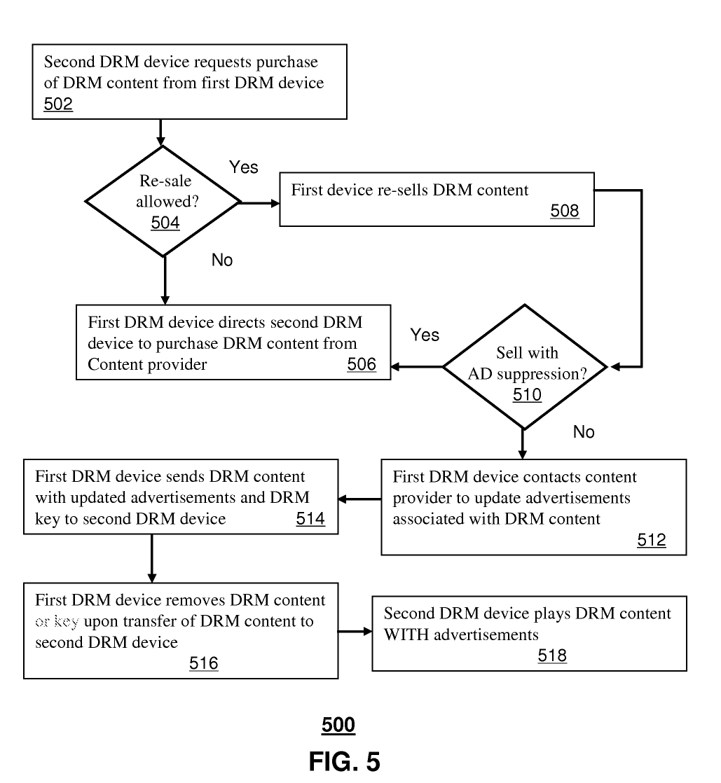

Referring to FIG. 5, a flowchart 500 illustrating further method steps for re-selling digital rights management (DRM) content having advertising (AD) contents attached thereto is shown. It should be noted that the steps of the flowchart 500 may be practiced with more or less than the number of steps shown. Moreover, the flowchart 500 can be practiced by the components presented in FIG. 1 though is not limited to practice by the components shown. Reference will also be made to FIG. 1 when describing the steps of the flowchart 500.

The flowchart 500 can start at step 502 at which the second DRM device 102 requests purchase of the DRM content 120 from the first DRM device 101. As an example, referring to FIG. 1, the first DRM device 101 and the second DRM device 102 may be operating over a peer-to-peer connection using a short range communalization (e.g. WiFi, BlueTooth, ZigBee). In such regard, the second DRM device 102 may request DRM content 120 directly from the first DRM device 101. At step 504, the RI 171, the first DRM device 101, or a DRM agent in the first DRM device 101, can determine if a re-sale of the DRM content 120 is allowed. Notably, a DRM agent may be present on the first DRM device 101, the second DRM device 102, or the content provider 110 to determine DRM content transfer rights. Moreover, each device may have a DRM agent to further confirm re-selling activities between the devices. For example, the first DRM device, or a DRM agent in the first DRM device, may check to see if the user of the first DRM device selling the DRM content 120 has purchased the re-sale rights 122, and/or the first DRM device 101 presents a license to re-sell the DRM content 120. If the first DRM device, or a DRM agent in the first DRM device, determines that the first DRM device 101 is not authorized to re-sell the DRM contents, the first DRM device 101 directs second DRM device to purchase DRM content from Content provider 110 at step 506.

If the RI 171, the first DRM device 101, or a DRM agent in the first DRM device, determines that the first DRM device 101 is entitled to re-sell the DRM contents, the first DRM device 101 re-sells the DRM content 120 to the second DRM device 102 as shown in step 508. At step 510, the RI 171, the first DRM device, or a DRM agent in the first DRM device, can determine if the second DRM device 102 is interested in purchasing the DRM contents 120 with advertisement suppression option 123. If so, the first DRM device 101 directs the second DRM device 102 to purchase DRM content from the content provider 110. Notably, the first DRM device 101 is not permitted to transfer the AD key 145 with the DRM contents 120 to the second DRM device in accordance with the terms of the re-sale rights 122. Accordingly, the second DRM device 102 can be directed to contact the content provider 110 to purchase the DRM contents with advertisement suppression option 123 in order to view the DRM contents 120 without the AD contents 140.

Returning back to step 510, if the RI 171, the first DRM device, or a DRM agent in the first DRM device, determines the second DRM device 102 is interested in purchasing the DRM contents 120 without advertisement suppression option 123, the first DRM device can contact the content provider 110 to update advertisements associated with DRM content at step 512. In one embodiment, the RI, the first DRM device 101, or a DRM agent in the first DRM device, can send a receipt of re-sale to the content provider acknowledging that a second DRM device 102 has purchased the DRM content through a re-sale from the first DRM device 101. In response, the advertising server 130 can refresh the AD contents 140, and the content provider can attach the updated AD contents 140 to the DRM content 120. In one arrangement, a link can be transmitted with the transfer of the DRM content, that when activated in response to presenting the DRM content, automatically downloads the updated AD contents 140. The AD contents 140 can be updated by the first DRM device 101, the content provider 110, the advertising server 130, the second DRM device 102, or any other suitable communication system or device.

At step 514, the first DRM device 101 sends the DRM content 120 with updated advertisements, the re-sale rights 122, and the DRM key 125 to the second DRM device 102. Updating the AD contents 140 is an option that may or may not be required. For example, if the DRM devices are operating in peer-to-peer mode without a server, the first DRM device 101 can transfer the DRM contents 120 with the existing AD contents 140. If however the advertising server 130 is available, the AD contents 140 can be updated. Notably, the transfer of the DRM contents 120 does not include the AD key in accordance with the terms of the re-sale.

Upon transferring the DRM key 125 to the second DRM device 102, the RI 171, the first DRM device 101, or a DRM agent in the first DRM device, removes the DRM content 120 or DRM key 125 on the first DRM device at step 516. In one arrangement, an outside peer or system can validate that the digital content is removed from the first DRM device 101 upon re-sale. In another arrangement, the DRM key 125 can be disassociated with the first DRM device 101 to ensure that the DRM content—if not properly removed—cannot be presented. This ensures that the digital content is removed or incapable of being presented on the first DRM device 101 after selling the DRM content 120. Upon the second DRM device 102 receiving the DRM content, re-sale rights 122, and associated DRM key 125, the DRM contents can be presented on the second DRM device 102 with the advertisements at step 518. The second DRM device 102 may also contact the content provider 110 directly to purchase the advertisement suppression option and receive the AD key 145 to suppress the advertisements during the presentation of the DRM content 120.

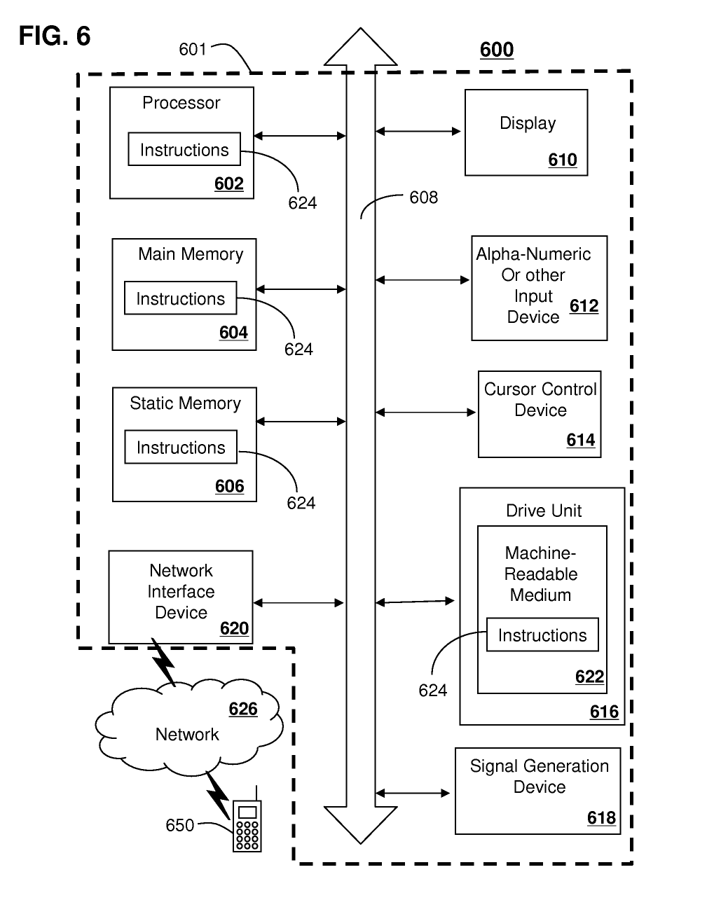

In another embodiment of the present invention as illustrated in the diagrammatic representation of FIG. 6, the DRM device 101 can be represented as a machine (e.g., a portable music player, a cellular phone, a laptop, a PDA, etc.) having a Rights Issuer (RI) or Presentation Module (PM) for re-selling digital rights management (DRM) content. The machine can include a controller 602 coupled to the RI or PM. Generally, in various embodiments the DRM device 101 can be thought of as a machine in the form of a computer system 600 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 601 and a sending device 650 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication or presentations. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU), or both), a main memory 604 and a static memory 606, which communicate with each other via a bus 608. The computer system 600 may further include a presentation device such the flexible display 610. The computer system 600 may include an input device 612 (e.g., a keyboard, microphone, etc.), a cursor control device 614 (e.g., a mouse), a disk drive unit 616, a signal generation device 618 (e.g., a speaker or remote control that can also serve as a presentation device) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor or controller 602 during execution thereof by the computer system 600. The main memory 604 and the processor or controller 602 also may constitute machine-readable media.

Dedicated hardware implementations including, but not limited to, application specific integrated circuits, programmable logic arrays, FPGAs and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A system for re-selling digital rights management (DRM) content having advertising (AD) contents attached thereto, comprising:
a rights issuer (RI) for providing re-sale rights to access and re-sell the DRM content provided by a content provider; and
a presentation module (PM) for presenting the DRM content without the AD contents if the DRM contents are purchased with an advertisement suppression option, and presenting the DRM content with the AD contents if the DRM contents are purchased without the advertisement suppression option.

2. The system of claim 1, wherein the RI responsive to a purchasing of the DRM content with the advertisement suppression option distributes an AD key that when accompanied with the DRM content prevents the PM from presenting the AD contents such that DRM content is presented without AD contents.

3. The system of claim 1, wherein the RI responsive to a purchasing of the DRM content without the advertisement suppression option distributes a DRM key that when accompanied with the DRM content permits the PM to present the DRM content with the AD contents such that DRM content is presented with the AD contents.

4. The system of claim 1, further comprising a first DRM device that in response to purchasing the DRM content without the advertisement suppression option receives a DRM key, and in response to purchasing the DRM content with the advertisement suppression option receives the DRM key and an AD key.

5. The system of claim 4, further comprising a second DRM device that in response to purchasing the DRM content from the first DRM device through a re-sale from the first DRM device, receives the DRM key.

6. The system of claim 5, wherein the RI, the first DRM device, or a DRM agent in the first DRM device, removes the DRM content or the DRM key from a first DRM device upon transfer of the DRM content to a second DRM device.

7. The system of claim 5, wherein the RI, the first DRM device, or a DRM agent in the first DRM device, sends a receipt of re-sale to the content provider acknowledging that a second DRM device has purchased the DRM content through a re-sale from a first DRM device.

8. The system of claim 5, further comprising an advertising server that receives a directive from the RI, the first DRM device, a DRM agent in the first DRM device, or content provider to update the AD contents before the DRM content is delivered through a re-sale from a first DRM device to a second DRM.

9. The system of claim 5, wherein the first DRM device and the second DRM device operate in a peer-to-peer mode or in a peer to server to peer mode.

10. A method for re-selling digital rights management (DRM) content, comprising:
attaching advertising (AD) contents to the DRM content; and
managing a presentation of the AD contents with the DRM content in accordance with the advertisement suppression option purchased with the DRM content that establishes whether the AD contents are presented with the DRM content.

11. The method of claim 10, further comprising:
determining if the advertisement suppression option is purchased with the DRM content; and
presenting the DRM content with the AD contents if the DRM contents are purchased without the advertisement suppression option, and presenting the DRM content without the AD contents if the DRM contents are purchased with the advertisement suppression option.

12. The method of claim 10, further comprising distributing a DRM key with a purchase of the DRM content that when accompanied with the DRM content permits a presentation the DRM content with the AD contents.

13. The method of claim 10, further comprising distributing an AD key if the advertisement suppression option is purchased with the DRM content, wherein the AD key prevents a presentation of the AD contents such that the DRM content is presented without AD contents.

14. The method of claim 10, further comprising sending a receipt of re-sale to a content provider supplying the DRM content acknowledging that a second DRM device has purchased the DRM content through a re-sale from a first DRM device.

15. The method of claim 12, further comprising delivering the DRM content without the AD key responsive to a re-sale of the DRM content.

16. The method of claim 12, further comprising directing a DRM device to a content provider that distributes the DRM content with a DRM key and an AD key.

17. The method of claim 10, further comprising updating the AD contents before the DRM content is delivered through a re-sale from a first DRM device to a second DRM device.

18. The method of claim 10, further comprising removing the DRM content or a DRM key upon a re-sale of the DRM content.

19. An electronic device for re-selling digital rights management (DRM) content having advertising (AD) contents attached thereto, comprising:
a presentation module (PM) for presenting the DRM content without the AD contents if the DRM contents are purchased with an advertisement suppression option, and presenting the DRM content with the AD contents if the DRM contents are purchased without the advertisement suppression option,
wherein a purchase of the advertisement suppression option produces a DRM key and an AD key, and a purchase of the DRM content without the advertisement suppression option produces the DRM key but not the AD key, and the PM presents the DRM contents on the electronic device without the AD contents if both the AD key and the DRM key are present, and presents the DRM contents on the electronic device with AD contents if the DRM key is present but the AD key is not present.

20. The electronic device of claim 19, wherein the electronic device, or a DRM agent in the electronic device, distributes the DRM key with the DRM content and AD contents attached thereto responsive to a second electronic device purchasing the DRM content from the electronic device in a re-sale of the DRM contents from the electronic device to the second electronic device, and the electronic device, or a DRM agent in the electronic device, transfers the DRM key with the DRM content and AD contents attached thereto without the AD key, such that the second device presents DRM content with AD contents, and the electronic device, or a DRM agent in the electronic device, removes the DRM content or the DRM key on the electronic device upon the re-sale of the DRM content to the second electronic device.
